(19) United States
(12) Patent Application Publication
(10) Pub. No.: US 2007/0163406 A1
(43) Pub. Date: Jul. 19, 2007

(54) Multiple sliding extension rod

(76) Inventor: Qing-Xiang Liu, Taiping City (TW)

Correspondence Address: CHARLES E. BAXLEY, ESQ., 90 JOHN STREET, THIRD FLOOR, NEW YORK, NY, 10038, US

(21) Appl. No.: 11/333,476

(22) Filed: Jan. 17, 2006

(51) Int. Cl. B25B 23/16; B25G 1/00

(52) U.S. Cl. 81/177.85

(57) ABSTRACT

A multiple sliding extension rod comprises an ejector pin disposed axially within its one end; a pressing head disposed radially through the wall of the extension rod with its end having an incline extended into the inclined pathway to allow the ejector pin reciprocating during pressing head being pressed and released; the ejector pin further comprising a ball-socket that consists of a first seat and a second seat successively wherein the first seat is deeper than the second seat. When said ejector pin reciprocates, the second seat pushes a retaining ball disposed in the wall of the extension rod upward and protuberant from the external surface of the extension rod; alternatively, the first seat receives the falling retaining ball and lead the retaining ball withdrawn from the external surface of the extension rod.

### BACKGROUND OF THE INVENTION

1. Field of the Invention

The present invention relates to hand tools and, more particularly, to an extension rod which is used to combine with various jaws, adapters, extension bars and other connective components suchlike. The multiple sliding extension rod can further perform as a gripping shank, which is capable of driving a tool assembly mounted thereon.

2. Description of Related Art

It is one of the major problems a current hand tool encounters that the hand tool is not always convenient and accommodative to be operated all the time especially when being operated in confined operating space, positions and with specific operating angles. To solve this problem, extensions have been provided to connect with various jaws, adapters, extension bars and other connective components suchlike to address all kinds of working needs.

A conventional extension rod generally has an ejector pin disposed at its one end and a pressing head further provided on the ejector pin. To press and release the pressing head causes single reciprocation. When the head is pressed, the ejector pin in turn moves toward a predetermined direction to make a retaining ball, which is disposed through the wall of the extension rod fall into a curvy ball-socket on the ejector pin. Therefore, the retaining ball moves backward from the surface of the rod and said connective component can be thereby loaded or unloaded. On the contrary, when the head is released, the ejector pin moves the reverse and the edge of the curvy ball-socket push up the retaining ball. Consequentially, the retaining ball partially appears at the external surface of the rod again and lodges in a ball-retainer on said connective component to retain the component with the extension rod thereby.

One problem of foresaid prior-art is that there is only one curvy ball-socket on the ejector pin to receive and prop the retaining ball. Especially when the retaining ball is pushed up, it is only propped by a small part of the edge of the curvy ball-socket and may not stay stable. Thus, the combination between the extension rod and the connective components may also be unstable.

Another problem of foresaid prior-art is that the pressing head always appears partially on the external surface of the rod even when being pressed. Although it may not be a defect, the inventor further considers that it somehow hinders the extension rod from its additional functions.

### SUMMARY OF THE INVENTION

It is one object of the present invention to provide a multiple sliding extension rod, wherein the retaining ball stays stable when it is pushed up to the external surface of the extension rod by the ejector pin. Eventually, a connective component mounted thereon can also be fixed steady.

It is another object of the present invention to provide a multiple sliding extension rod, wherein the pressing head and retaining ball can completely be immerged in and do not appear at the surface of the extension rod while the pressing head is pressed. Accordingly, a tool assembly can pass over the pressing head as well as the retaining ball and be fastened on the extension rod. Thus, a user can grip the extension rod as a long handle to drive the tool assembly rotating relatively more labor-savingly.

To achieve these and other objects of the present invention, the multiple sliding extension rod comprises:
an extension rod;
a pin hole disposed axially within one end of the extension rod;
an ejector pin disposed within said pin hole correspondingly; a spring provided between the adjacent surfaces of the ejector pin and pin hole; an inclined pathway formed on the ejector pin relatively near said spring; a ball-socket that consists of a first seat and a second seat formed on the ejector pin relatively far from said spring, wherein the depth of the first seat is larger than that of the second seat and the first seat connects the second seat upward with a slope and said second seat has a flat bottom;
a pressing head threading through a hole formed on the wall of the extension rod and with its end inside the rod inserting the inclined pathway of the ejector pin and contacting the wall of the pathway at one side with an incline;
a retaining ball disposed in a bore through the wall of the extension rod and settled against the ball-socket.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is an exploded view of the associating end of an extension rod according to the present invention;

FIG. 2 is a perspective view of the associating end of an extension rod according to the present invention;

FIG. 3 is a sectional view of the associating end of an extension rod according to the present invention;

FIG. 4 is a schematic drawing showing the associating end of an extension rod according to the present invention combining with a connective component;

FIG. 5 is a sectional view of the associating end of an extension rod according to the present invention with a connective component combined and fastened thereon;

FIG. 6 is an exploded view of an extension rod according to the present invention combined with a tool assembly;

FIG. 7 is a perspective view of an extension rod according to the present invention combined with a tool assembly;

FIG. 8 is a view showing a tool assembly moving on an extension rod according to the present invention.

### DETAILED DESCRIPTION OF THE PREFERRED EMBODIMENT

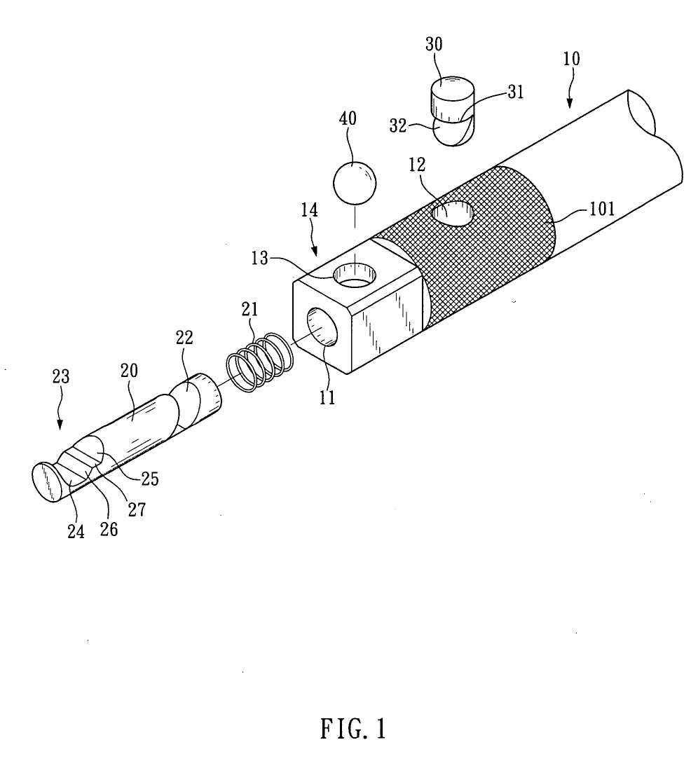

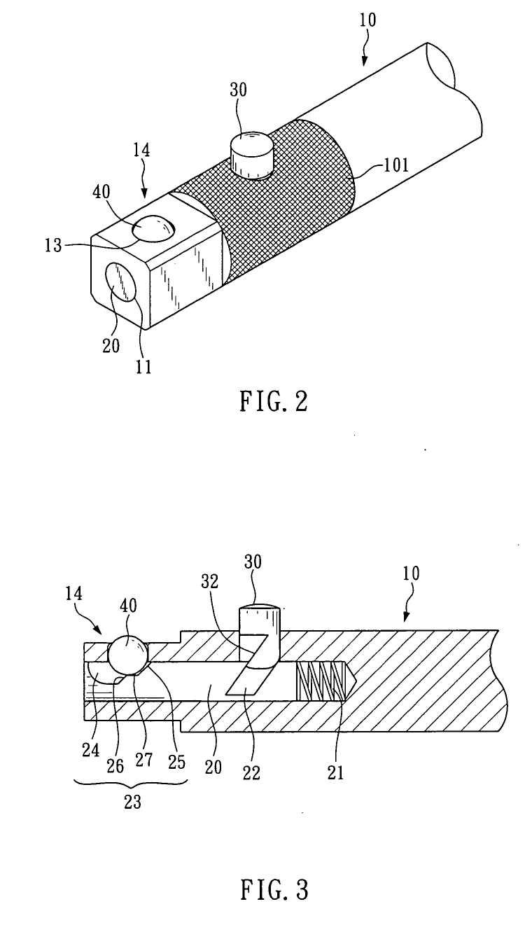

Referring to FIGS. 1, 2 and 3, a multiple sliding extension rod of the present invention comprises:
an extension rod 10;
a pin hole 11 disposed axially within one end of the extension rod 10;
an ejector pin 20 situated within said pin hole 11 correspondingly; a spring 21 provided between the adjacent surfaces of the ejector pin 20 and pin hole 11; an inclined pathway 22 formed on the ejector pin 20 relatively near said spring 21; a ball-socket 23 that consists of a first seat 24 and a second seat 25 formed on the ejector pin 20 relatively far from said spring 21, wherein the seats are arranged in succession in the direction parallel to the axle of the ejector pin 20 and the depth of the first seat 24 is larger than that of the second seat 25 and the first seat 24 connects the second seat 25 upward with a slope 26 and said second seat having a flat bottom 27;
a pressing head 30 having an indentation 31 which forms an incline 32 parallel to one side of the wall of said inclined pathway 22; further, said pressing head 30 disposed in the hole 12 of the extension rod 10 with the end about the incline 32 inside the inclined pathway 22 of the ejector pin 20 and the other end extended out of the hole 12;
a retaining ball 40 disposed in a bore 13 on the wall of the extension rod 10 and settled against the ball-socket 23 on the ejector pin 20.

As shown in FIG. 3, the ejector pin 20 is at a stationary position as the elasticity of the spring 21 acts thereon. One end of the pressing head 30 protuberates from the hole 12 to receive a pressing action from a user. The other end of the pressing head 30 extends into the opening of the inclined pathway 22 inside the ejector pin 20 and has part of its incline 32 stayed close to part of the wall of the inclined pathway 22. Consequentially, the inclined pathway 22 hinders the pressing head 30 from falling out along the axial direction of the hole 12. Further, the retaining ball 40 is settled in the second seat 25 with a certain part appearing at the bore 13 under the support of the flat bottom 27.

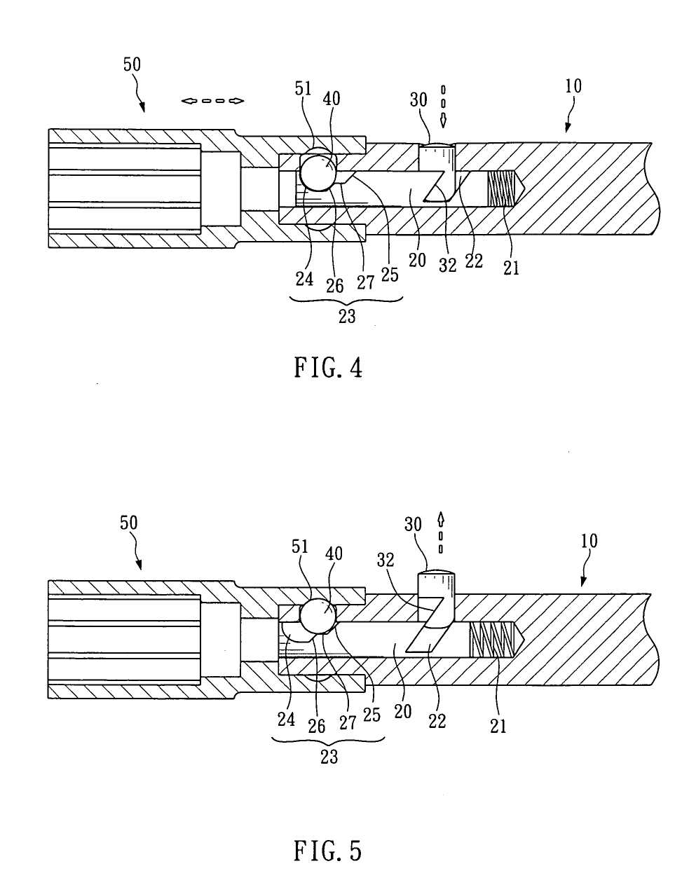

In FIG. 4, the pressing head 30 is now pressed downward. Following the pressing head 30 moving inward the extension rod 10, the incline 32 slides along one side of the wall of inclined pathway 22 and leads the ejector pin 20 moving against and compressing the spring 21 to bring the first set 24 to the retaining ball 40. Since the first seat 24 is deeper than the second seat 25, when the retaining ball 40 falling into the first seat 24, it no more appears at the external surface of the extension rod 10. Thereby, the extension rod 10 allows a connective component 50, such as a pair of jaws, an adapter or an extension bar, mounting on the end of the extension rod 10.

In FIG. 5, when the pressing head 30 is released, the spring 21 resiles following and pushes the ejector pin 20 backward to its stationary position. In turn, the side incline 32 slides upwards along the wall of inclined pathway 22 to bring the pressing head 30 rising from the hole 12 again. Meantime, the slope 26 of the ball-socket 23 pushes the retaining ball 40 to retain it in the ball-retainer 51 of the associative assembly 50. Further, the flat bottom 27 of the second seat 25 props the retaining ball 40, so that when the retaining ball 40 combines with the associative assembly 50, it would not sink into the ball-socket 23. Once the retaining ball 40 stays stable, the stability of the combination between the extension rod 10 and connective component 50 therefore improved.

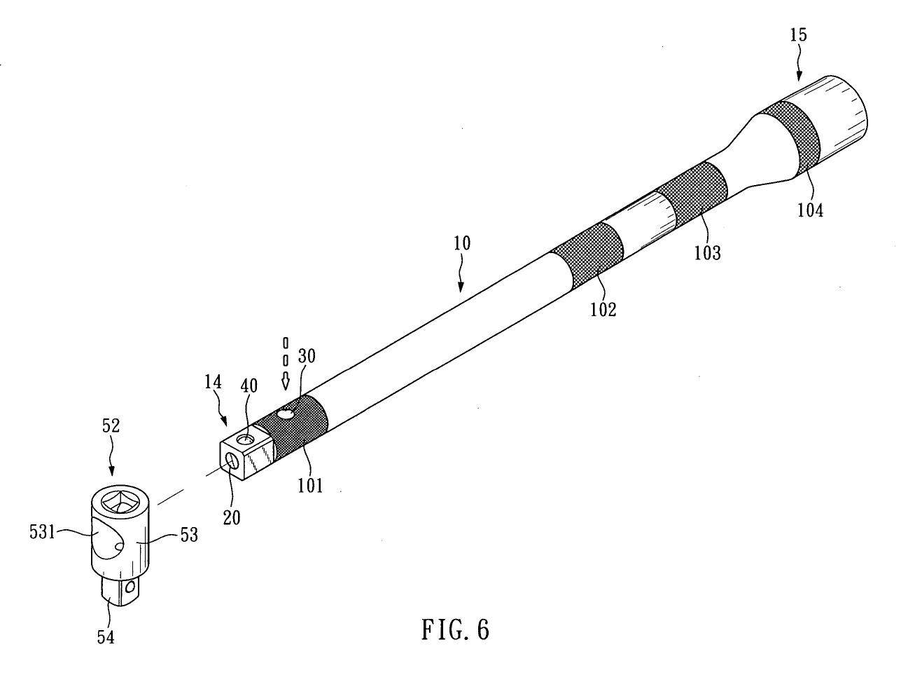

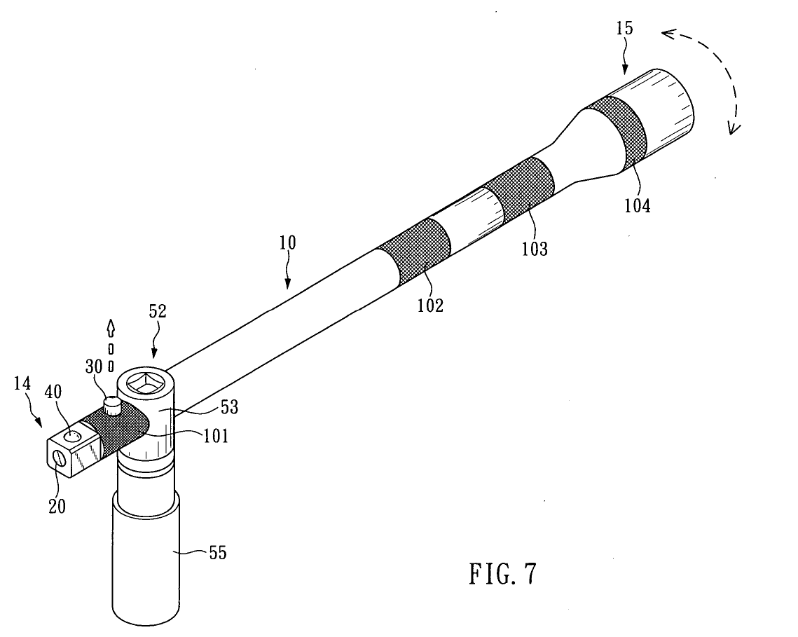

Referring to FIGS. 6 and 7, the end of the extension rod 10 mounted by a connective component 50 is denominated as associating end 14 while the other end is denominated as operating end 15. The diameter of said operating end 15 is large than the diameter of the sleeve construction of the extension rod 10.

The depths of the second seat 25 and inclined pathway 22 are deep enough to allow the retaining ball 40 and pressing head 30 completely immerged in the hole 12 and bore 13 and not appearing at the external surface of the extension rod 10 such that a tool assembly 52 can pass over the pressing head 30 and be coupled with the body of the extension rod 10.

Foresaid tool assembly 52 has an extension-rod-connecting portion 53 and a tool-connecting portion 54. The extension-rod-connecting portion 53 further has a radial hole 531 for receiving the extension rod 10 therein. The tool-connecting portion 54 can be combined with a tool 55 such as a sleeve. Thereupon, the extension rod 10 comes perpendicular to the tool assembly 52 and a user can grip the extension rod 10 as a lever to drive the tool assembly 52 relatively more labor-savingly. The extension rod of the present invention further provides several anti-slip segments 101, 102, 103, and 104 to prevent slips during a user's usage.

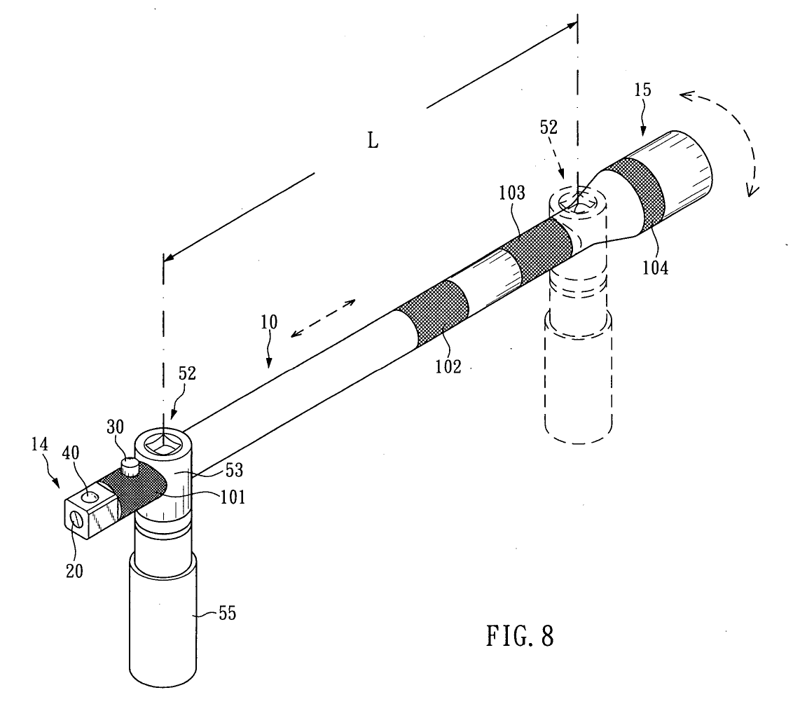

In FIG. 8, a tool assembly 52 is confined on the extension rod 10 by the pressing head 30 and larger diametric operating end 15. The tool assembly 52 can move along a distance (L) between a first position where the tool assembly 52 is retained by the pressing head 30 and a second position where the tool assembly 52 is retained by the larger diametric operating end 15. Further, the tool assembly 52 can be fixed at any point within the distance (L).

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A multiple sliding extension rod substantially comprises:
an extension rod;
a pin hole disposed axially within one end of the extension rod;
a pressing head disposed radially within a hole through the wall of the extension rod;
a retaining ball disposed in bore through the wall of the extension rod;
an ejector pin situated within said pin hole correspondingly can reciprocate inside the pin hole under the control of the pressing head; the ejector pin further comprising a first seat and second seat which are arranged in succession and corresponding to the position of the retaining ball; wherein the first seat is deeper than the second seat.

2. The multiple sliding extension rod as claimed in claim 1, wherein, the interface of the first seat and the second seat is a slope.

3. The multiple sliding extension rod as claimed in claim 1, wherein, the second seat comprises a flat bottom.

4. The multiple sliding extension rd as claimed in claim 1, wherein, a inclined pathway is formed on the ejector pin and an incline parallel to the inclined pathway is formed on the body of said pressing head; wherein the pressing head is with the end about the ejector pin stretched into the inclined pathway and its incline touches one side of the wall of the inclined pathway.

5. The multiple sliding extension rod as claimed in claim 4, wherein, when the pressing head has the end about the ejector pin is positioned at the bottom end of the inclined pathway, the opposite end of the pressing head does not protuberate from the external surface of said extension rod at all.

6. The multiple sliding extension rod as claimed in claim 5, wherein, when part of the retaining ball is settled in the first seat, the retaining ball does not protuberate from the external surface of said extension rod at all.

7. The multiple sliding extension rod as claimed in claim 6, wherein, a tool assembly is mounted on the body of the extension rod through a radial hole disposed on one end of the tool assembly.

8. The multiple sliding extension rod as claimed in claim 1, wherein, the end of the extension rod about said ejector pin, pressing head and retaining ball is denominated as associating end while the opposite end is denominated as operating end; wherein the diameter of the operating end is larger than the diameter of the body of the extension rod.

9. The multiple sliding extension rod as claimed in claim 8, wherein, the operating end comprises a sleeve construction.

10. The multiple sliding extension rod as claimed in claim 1, wherein, the body of the extension rod comprises at least one anti-slip segment.
